(19) United States
(12) Patent Application Publication
(10) Pub. No.: US 2008/0201188 A1
(43) Pub. Date: Aug. 21, 2008

(54) Niche-oriented advertising networks platform and methods of operating same

(76) Inventors: Steven C. Heyman, San Mateo, CA (US); Heidi K. Carson, Cupertino, CA (US); Tanya Y. Cheng, Mountain View, CA (US); Chingwei Peter Cheng, Foster City, CA (US)

Correspondence Address: GERALD B ROSENBERG;NEW TECH LAW, 260 SHERIDAN AVENUE, SUITE 208, PALO ALTO, CA, 94306-2009, US

(21) Appl. No.: 12/069,768

(22) Filed: Feb. 13, 2008

Related U.S. Application Data
(60) Provisional application No. 60/901,968, filed on Feb. 17, 2007.

(51) Int. Cl. G06Q 30/00; G06Q 10/00

(52) U.S. Cl. 705/7; 705/14

(57) ABSTRACT

System and methods of constructing and operating a network of advertising networks in support of the real-time selection and distribution of creatives to network connected client computer systems for composited presentation on Web pages served to client computer systems. The network of networks is constructed by associating a plurality of publisher sites with a plurality of advertising networks, with each publisher site associated with one or more advertising networks, and associating a plurality of advertising campaigns with the plurality of advertising networks, with each advertising campaign associated with one or more of the advertising networks and further defined by respective campaign criteria. A campaign prioritization list is produced for each publisher site, generated based on a competitive analysis of respective campaign criteria, including a normalized campaign buy basis, employing a past-performance-based projection of a competitive completion of the advertising campaigns. Advertising creatives are served, in real-time, in response to service requests received from client computer systems, where the advertising creative selection is determined from the campaign prioritization list dependent on the respective publisher site and real-time evaluation of the respective campaign criteria.

This application claims the benefit of U.S. Provisional Application No(s). 60/901,968, filed Feb. 17, 2007.

### BACKGROUND OF THE INVENTION

1. Field of the Invention

The present invention is generally related to networked interactive computer information distribution systems and, in particular, to a computer network system platform providing for the controlled construction and operation of niche-oriented advertising networks.

2. Description of the Related Art

With the ongoing adoption and use of the Internet for Web-based information delivery and commerce of various description, collateral opportunities for marketing and adverting have also grown. Internet advertising revenues, broadly covering commercial online advertising sales, were estimated at $4.9 billion for the first quarter of 2007. These revenues represent the placement of advertisements on Web sites of various description, including commercial online services, such as local and national retail businesses, subscription and free information service providers, including blogs, wikis and other online diaries that provide commentary or news on a particular subject, such as food, politics, sports, entertainment, or local, national, or foreign events, and other companies selling online advertising.

Particularly due to the growth and extent of the Internet, implementing and managing online adverting campaigns are complex to plan and often both labor and cost intensive to run. The number and differences in business practices and technology of content publication sites, variously referred to as content providers or publishers, are vast. Conventionally, to implement a broad-based online advertising campaign, specific business arrangements must be established with many different publishers, and various advertisements, typically referred to as creatives, must be structured and delivered either to the publishers or third-party content distributors with suitable changes made to the Web pages served by the publisher to suitably incorporate the creatives. Appropriate contractual arrangements with the third-party content distributors, as well as with third-party performance verification and analysis companies, must be continually maintained and monitored. Some conventional tools are known to exist to automate aspects of the relation and required operations between a given advertiser and publisher. Nonetheless, given that many effective advertising campaigns optimally run for periods of only a few days to a few weeks, the effort to plan and implement a successful online advertising campaign is substantial.

In order to avoid or at least reduce the complexities of multi-site advertising campaigns, advertisers will often focus heavily on what can effectively be termed enterprise sites and lead-brand sites. Enterprise sites present the appearance of multiple publishers operating sites offering a relative diverse set of content. Typically, enterprise publishers are commonly controlled and the sites commonly administered. Lead-brand sites similarly present the appearance of multiple publishers of diverse content, but are typically anchored by a primary publishing entity and contain other sites closely allied at least by long term business relationships. In both cases, the planning and implementation of advertising campaigns are simplified by the potential advertising base represented by a more limited or at least more conveniently operated set of publishers.

Enterprise and lead-brand sites cannot, however, be relied upon alone to provide a satisfactory advertising base for many advertising campaigns. The desired target demographics may simply extend beyond that represented by the enterprise and lead-brand sites or require a more defined, typically local context than afforded by characteristically regional and national orientations of enterprise and lead-brand sites. In contrast, niche sites are particularly valued as developing relatively tightly focused communities based on some well-defined common interest or theme. These niche sites are, in general, represented by blogs, editorial and news portals, social networking sites, and specialty product review sites, and other focused content sites. Often, advertising on niche sites is able to yield a far greater return on marketing investment for information and services related to the direct and allied interests of the niche.

Advertising access to niche sites is, however, limited by the complexity of not just planning and implementing a campaign, but also of finding and validating the worth of different niche sites. While seemingly small niche sites are able to reliably vend very sizable numbers of page impressions, many others are highly variable in the number of page impressions, even to the point of ceasing to publish. Consequently, a clear need exists for a better strategy and system for the planning and implementation of niche-oriented online advertising campaigns.

### SUMMARY OF THE INVENTION

Thus, a general purpose of the present invention is to provide an efficient computer network platform providing for the controlled construction and operation of advertising network communities to aggregate and leverage a broad range of sites, including niche-oriented sites, for the planning, implementation, and management of online advertising campaigns.

This is achieved in the present invention by constructing and operating a network of advertising networks to support of the real-time selection and distribution of creatives to network connected client computer systems for composited presentation on Web pages served to client computer systems. The network of networks is constructed by associating a plurality of publisher sites with a plurality of advertising networks, with each publisher site associated with one or more advertising networks, and associating a plurality of advertising campaigns with the plurality of advertising networks, with each advertising campaign associated with one or more of the advertising networks and further defined by respective campaign criteria. A campaign prioritization list is produced for each publisher site, generated based on a competitive analysis of respective campaign criteria, including a normalized campaign buy basis, employing a past-performance-based projection of a competitive completion of the advertising campaigns. Advertising creatives are served, in real-time, in response to service requests received from client computer systems, where the advertising creative selection is determined from the campaign prioritization list dependent on the respective publisher site and real-time evaluation of the respective campaign criteria.

An advantage of the present invention is, through the establishment of a network of networks of publishers, including in particular niche-oriented publisher sites, advertisers have an efficient forum for the selection of publishers, as part of coordinated network communities and individually, for participation in online advertising campaigns. Through use of the present invention, various network communities can be effectively defined and managed as needed by independent network builders to address different perceived and accepted advertising market models. Network communities can be formed with publishers participating in multiple network communities that may be variously independent, overlapping, and subsets of other network communities.

Another advantage of the present invention is that the system enables coordinated and competitive participation by multiple network builders to independently establish and recruit publishers to participate in relevant niche-oriented network communities. While capable of providing the network builders with unified management and control over administration and policy usage of network communities, the system flexibly provides network builders the ability to independently establish controlling terms and conditions for the network builder controlled network communities. A storefront paradigm provides a convenient access model for use by advertisers wishing to include one or more network communities in a particular advertising campaign.

A further advantage of the present invention is that the system enables comprehensive and egalitarian competition for use of the inventory of advertising space within and among the network communities. Subject to the particular constraints of concurrently running advertising campaigns, inventory use is effectively managed through a system of dynamic competition. Bid pricing, sponsorship requirements, and campaign performance criteria are dynamically balanced to determine prioritization for use of inventory.

Still another advantage of the present invention is that the system can provide an effective, dynamic evaluation of inventory availability in qualification for advertising campaign buys. The present invention is thus capable of significantly improving the ability of advertisers to optimally plan advertising campaigns with a substantial degree of certainty that campaign performance targets will be met particularly where a campaign spans multiple network communities.

Yet another advantage of the present invention is that the system provides for the further real-time selection of creatives to meet the performance requirements determined through the competitive campaign prioritization process. Pacing, frequency, and other performance controls can be evaluated in real-time relative to the demand-request for creatives for categorized advertising spaces. Creative delivery is thus optimized through use of the present invention for concurrently running campaigns span multiple and different network communities.

### BRIEF DESCRIPTION OF THE DRAWINGS

FIG. 1 is a network system diagram illustrating a preferred operating environment for the implementation of preferred embodiments of the present invention;

FIG. 2 is a system flow overview diagram showing the operative relationships of a hosted networks of network architecture as implemented in a preferred embodiment of the present invention;

FIG. 3 is a system relationship diagram illustrating the association advertisers, network builders, and publishers as defining communities within a network of networks in accordance with preferred embodiments of the present invention;

FIG. 4 provides a software system architecture diagram illustrating a preferred networks and accounts management association provided for the benefit of advertisers, network builders, and publishers in accordance with preferred embodiments of the present invention;

FIG. 5 provides a process flow diagram describing the creation and management of networks as implemented in accordance with preferred embodiments of the present invention;

FIG. 6 provides a process flow diagram describing the selective creation and management of advertising campaign buys as implemented in accordance with preferred embodiments of the present invention;

FIG. 7 illustrates the top-level process architecture of the network of networks hosted management system as implemented in accordance with preferred embodiments of the present invention;

FIG. 8 is a process diagram illustrating operation of the campaign buy and performance prioritization services as implemented on a networks host server in accordance with preferred embodiments of the present invention;

FIG. 9 is a process diagram illustrating a preferred method of determining a normalized basis for multiple buy types as implemented in accordance with preferred embodiments of the present invention;

FIG. 10 is a process diagram illustrating operation of the creative selection and real-time campaign performance services as implemented on a campaign advertisement server in accordance with preferred embodiments of the present invention; and

FIG. 11A-C illustrates campaign performance management operations that can be implemented by the creative selection and real-time campaign performance services as implemented on a campaign advertisement server in accordance with preferred embodiments of the present invention.

### DETAILED DESCRIPTION OF THE INVENTION

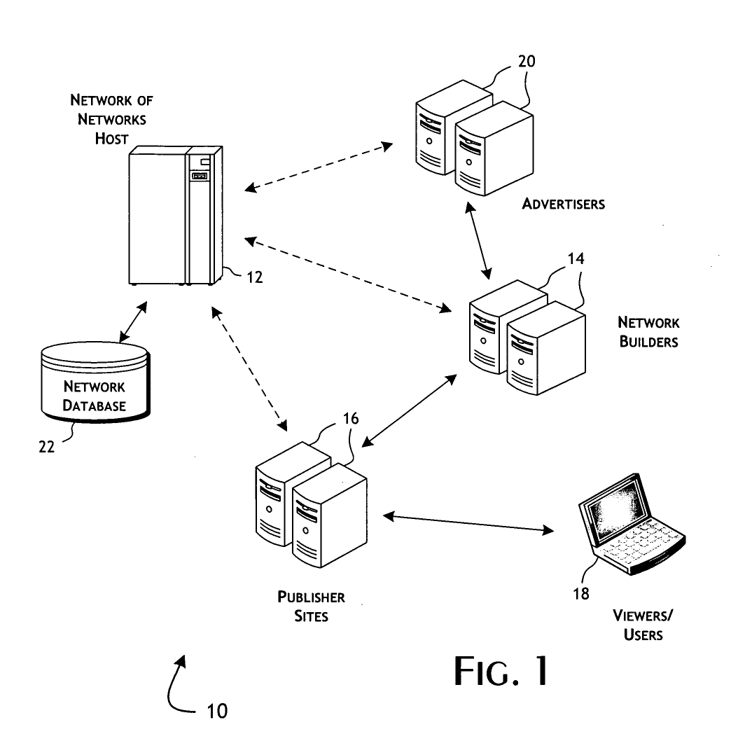

A simplified depiction of a preferred operating environment, appropriate to provide a basis for the following discussion of the principles of the present invention, is shown in FIG. 1. In the following discussion, preferred and alternate embodiments of the present invention are presented in detail appropriate for those skilled in the art to practice the invention. For convenience of discussion, like reference numerals are used to designate like parts depicted in one or more of the figures.

Generally in regard to FIG. 1, the present invention functionally enables the establishment of niche communities of Web site publishers for the purpose of leveraging economic and other benefits from publication of substantively related or otherwise complementary content. These niche content-related communities are preferably associated by actual or perceived relationships in the nature of the content published, at least as viewed by potential Web users. For example, niche community relationships between Web site publishers may exist due to a common content focus on sports, hobbies, health, lifestyle, food, pets, parenting, gaming, personal investing, home renovation, charity, theater, travel, fashion, and politics. In many cases, niche communities may overlap in part, as in the case of lifestyle, food, and travel, and in the case of retirement, personal investment, and politics, or in whole, such as in the case of lifestyle, personal fitness, and heart health, and in the case of entertainment, live theater, and musicals. The particular form of the Web sites published by individual publishers, even within a single niche community, may include any of the various types of Web-based publications, including blogs, wikis, video sharing sites, social online-communities, product review sites, online stores, and online newsletters. The present invention places no limit on the nature of a participating publisher, which can range from an individual publishing an individual site to corporate entities responsible for publishing a wide variety of different sites.

The present invention contemplates that the number of potential niche content-related communities will be large and that the overlapping, published content driven relationships between communities will result in complex associations. The present invention therefore provides for functional construction and management of a network of networks representing niche content-related communities. In the preferred embodiments of the present invention, niche content-related communities are constructed to leverage access to advertisers, reduce the complexity and other practical barriers to collectively participating in advertising campaigns, and maximize advertising revenues by establishing and presenting advertisers with well-defined content relevant advertising channels.

FIG. 1 shows a preferred implementation of a hosted network of networks architecture, where a networks server host 12 provides niche content-related community network administration and related services redirected through network builder servers 14. Individuals and companies, typically participating as independent agents, work as network builders to locate, contractually aggregate, and manage publisher sites 16 as well-defined niche content-related communities, where well-defined is a reflection of the network builder's perception of the marketability of a particular collection of publisher members for purposes of advertising. Each network builder is permitted to establish and manage any number of different niche content-related community networks. In the preferred embodiments, the publisher sites 16 are conventional Web servers publishing content originated by the publisher in the form of Web pages publicly accessible to conventional users of various client computer systems 18. When joining a niche content-related community network operated by a particular network builder, a publisher typically agrees to be bound by the network operating policies established for that network by the network builder. These network operating policies characteristically include advertising rates and requirements, revenue sharing percentages and other the terms and conditions.

Advertisers, through advertiser systems 20, may access Web pages, hosted by or through the network builder servers 14, that describe the different niche content-related community networks managed by a particular network builder, as well as the relevant network operating policies, including composition of the publisher base, advertising rates and requirements, and other terms and conditions required to establish an advertising campaign commitment.

In accordance with the preferred embodiments of the present invention, the various configuration data representing the niche content-related community networks, including network operating policies, established by the network builders are stored in a host network database 22. Details of the different participating publishers sites, including the available inventory of advertisement impression spaces, representing defined page layout slots, associations with the network builders, and various use metrics, are also preferably stored by the host network database 22. In addition, advertiser and advertising campaign data, including in particular campaign associations with particular niche content-related community networks, are stored in host network database 22. While various aspects of this data could be stored variously by the network builder, publisher site and advertiser servers 14, 16, 20, centralized storage for consistent maintenance and use by and through the networks server host 12 is preferred.

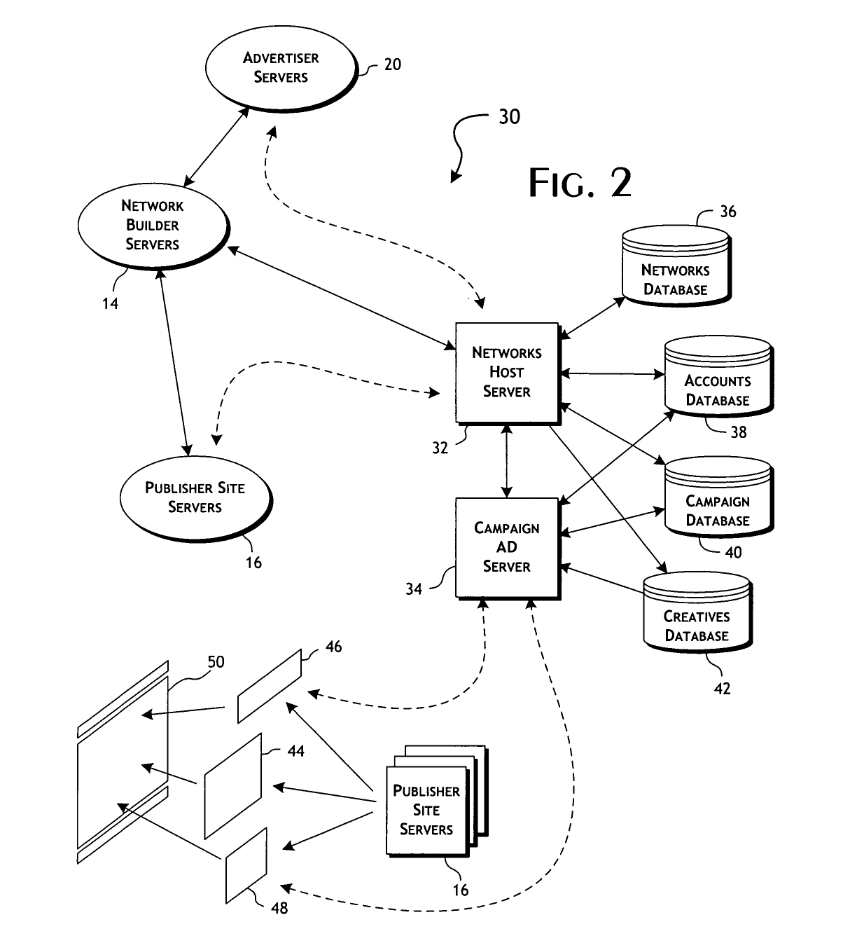

The operative relationships of the hosted network of networks architecture 30 as implemented by a preferred embodiment of the present invention are further detailed in FIG. 2. The network of networks host 12 is preferably constructed as a combination of a networks host server 32 and real-time campaign advertisement server 34. A networks database 36 is used to store network configuration data principally to identify the various network builders and the various aspects of the niche content-related community networks established by the network builders. The preferred contents of the networks database 36 are identified in Table 1

TABLE 1
Networks Database

| | |
|---|---|
| Network Builder | Name and contact identifying information for each |
| | network builder. |
| Policies | The operative policies defined by the managing |
| | network builders for corresponding niche content- |
| | related community networks. |
| Networks | Name and description of each niche content-related |
| | community network including the managing network |
| | builder. |
| Publishers Sites | Name and identifying information for each publisher |
| | and applicable commission structure. |
| Inventory | For each publisher site, an identification of the |
| | advertising spaces available on the publishable Web |
| | pages, including type, size and orientation. |
| Traffic | Traffic counts for each publisher site. |

An accounts database 38 is used to store accounting and financial reporting data for the various transactions managed by and through the network of networks host 12. The preferred contents of the accounts database 38 are identified in Table 2.

TABLE 2
Accounts Database

| | |
|---|---|
| Network Builder | For each network builder, a current account balance |
| | including niche content-related community network |
| | performance account detail, payment history for |
| | current account, payment timing, payment currency, |
| | and other account preferences. |
| Publisher | For each publisher, a current account balance |
| | including network builder and niche content-related |
| | community network performance account details, |
| | payment history for current account, payment |
| | timing, payment currency, and other account |
| | preferences. |
| Advertiser | For each advertiser, a current account balance |
| | including campaign account details, campaign |
| | payment history, invoice terms, invoice currency, and |
| | other account preferences. |

A campaign database 40 is used to store advertiser identification and campaign configuration data principally to identify the various advertisers, the controls and operative aspects of each running campaign, performance data for each running campaign, and historical performance data for past campaigns. The preferred contents of the campaign database 40 is identified in Table 3.

TABLE 3
Campaign Database

| | |
|---|---|
| Advertiser | Name and identifying information for each |
| | advertiser. |
| Campaign | Advertiser reference, campaign identifier, and |
| | controlling terms for each campaign, including: |
| | begin date |
| | end date |
| | pacing |
| | budget |
| | day part |
| | user impression frequency per day |
| | geographical aspects |
| | browser aspects |
| | operating system aspects |
| | browser language aspects |
| | connection speed aspects |
| | user/creative rotation aspects |
| | ad size and ad creatives |
| Performance | For each campaign, a log of campaign performance |
| | details, including: |
| | site and ad space page impressions and click |
| | throughs |
| | creative served |
| | date served |
| | day part |
| | location |
| | browser |
| | operating system |
| | browser language |
| | connection speed |

A creatives database 42 is provided to store creatives as supplied by or on behalf of advertisers for use in ongoing campaigns. Preferably, the creatives database 42 is optimized for real-time retrieval of the creatives by the campaign advertisement server 34.

In the preferred embodiments, network builders each typically operates a network builder server 14 to manage the community aspects of their niche content-related community networks and corresponding publisher Web sites 16. These network builder servers 14 preferably provide access to a Web-based community management application hosted or otherwise accessible through the network builder servers 14. In the preferred embodiments, the niche content-related community network administration and reporting Web pages are typically redirected from a Web page server application executed on the networks host server 32.

For the benefit of the network builders, redirected administrative Web pages support the creation, modification, and deletion of individual niche content-related community networks, the creation and revision of charter descriptions of the different niche content-related communities networks, and the definition and maintenance of network builder policy sets that define the parameters of advertiser campaign orders permitted or supported for particular niche content-related community networks and the applicable commission structure for revenue sharing between the managing network builder and publisher sites within a corresponding niche content-related community network. Redirected reporting Web pages preferably provide network builders with summary listings of the constitution and status of corresponding managed niche content-related community networks, as well as performance and revenue summaries of present and past executed campaign orders.

Publishers, acting through publisher site servers 16 and network builder servers 14, preferably access a separate set of Web pages specific to the administration and reporting of niche content-related community network participation and campaign performance of particular publisher sites. In the preferred embodiments of the present invention, the Web pages are again produced by and redirected from the networks host server 32. These administration Web pages permit individual publisher sites to be added and removed from different niche content-related community networks, and to define and manage the creative inventory represented by the Web pages published by each publisher site. The inventory of a particular publisher site 16 is represented by the page composition, including type (image, text, rich media, video, pop-up, pop-under), size (height and width) and position (top, bottom, left, right, inset), of the Web page embedded spaces available for population by creatives and page traffic. Page traffic for a publisher site is initially estimated by the publisher and subsequently refined based on the actual history of creative service requests received from the publisher site as captured by the campaign advertising server 34.

Client computer systems 18, in requesting Web pages 50 served by the publisher site server 16, indirectly access the campaign advertising server 34. As delivered to a client computer systems 18, a Web page 50 preferably embeds any number of presentation code blocks 44, 46, 48 that are, in turn, responsible for retrieving instance creatives to be used in the compositing of the Web page 50 for presentation. The preferred form and operation of the presentation code blocks 44, 46, 48 are described in co-pending application System and Method for Managing Presentation and Behavioral Use of Web Display Content, invented by Christopher Levine, U.S. patent Ser. No. ______ (Ser. No. 11/504,259; filed Aug. 14, 2006), assigned to the assignee of the present application, and which is hereby incorporated by reference. In summary, execution of a presentation code block 44, 46, 48 locally by the client Web browser application produces a request for a corresponding presentation element from the campaign advertising server 34. In the preferred embodiments, a returned presentation element will include a creative and associated layout information to be used in compositing the creative into the Web page 50. A presentation element request preferably encodes information collected by the presentation code block 44, 46, 48, including information pre-coded into the presentation code block, such as a pre-set advertising space identifier, run-time acquired system information, such as the operating system type and local, a publication site server 16 identifier, and the browser brand and version, and cookie data stored on the client computer system 18 by prior executed presentation code blocks 44, 46, 48. Based on the request provided information, the campaign advertising server 34, in real-time, determines and returns corresponding presentation elements for each of the presentation code blocks 44, 46, 48. In completing evaluation of the presentation code blocks 44, 46, 48, the delivered creatives are composited into corresponding advertising spaces of the Web page 50.

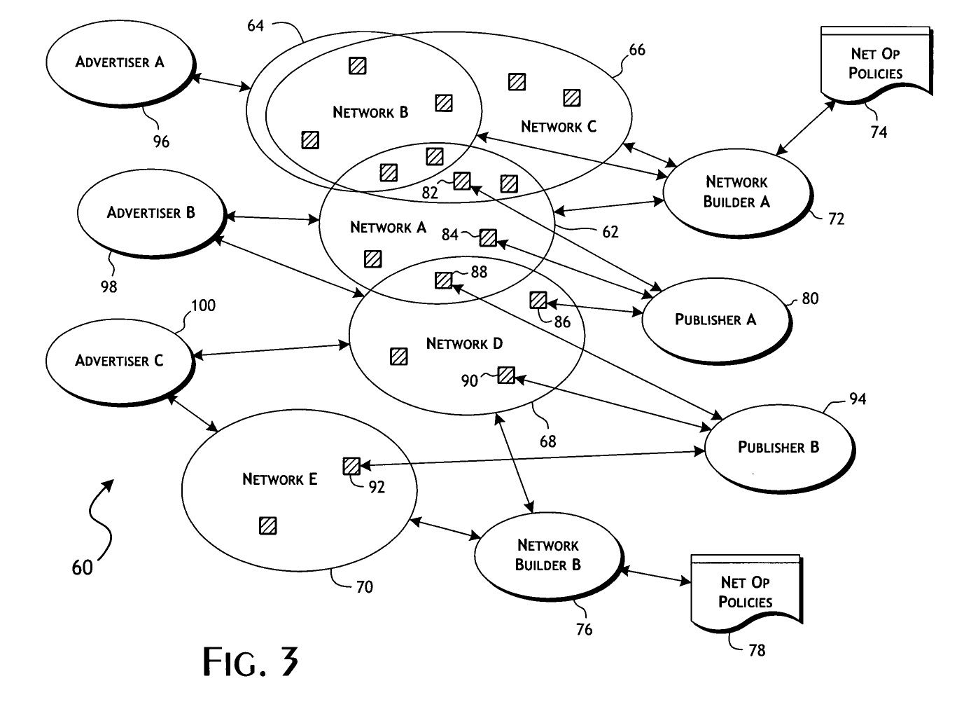

An exemplary realization 60 of the hosted network of networks architecture 30, as implemented by a preferred embodiment of the present invention, is shown in FIG. 3. Niche content-related community networks A-E 60, 62, 64, 66, 68, 70, functionally established by the network of networks host 12, represents variously overlapping and subsetted communities of content interrelated publisher sites 16. As generally shown, a network builder A 72 can establish multiple networks, subject to a defined set of network operating policies 74, based on perceived viewer demographics for the content published by the various included publisher sites 16. The overlap between network A 62 and networks B-C 64, 66 reflects a perceived overlapping of content published by the subsetted publisher sites 16. Network B 64, as shown, represents a specialized, typically niche content oriented aspect of the network C 66. Other niche content-related community networks, independently of whether managed by the same or different network builders, may define overlaps, subsets, and independent collections of publisher sites 16. As shown, network builder B 76 establishes, subject to a separate defined set of network operating policies 78, an overlapping network D 68 and distinct network E 70.

Content, brand or otherwise distinguishable publisher sites 16, such as publisher sites 82, 84, 86 operated by a publisher A 80 and publisher sites 88, 90, 92 operated by a publisher B 94 may be signed by different network builders to participate in different niche content-related community networks, again typically dependent on the perceived relation of the content published by each site 82, 84, 86, 88, 90, 92 and the different networks A-E 60, 62, 64, 66, 68, 70.

In accordance with the present invention, the distinct demographic identity of the different niche content-related communities realized by as networks A-E 60, 62, 64, 66, 68, 70 thus enables advertisers 20, such as advertisers A-C 96, 98, 100 to more effectively identify and correspondingly access demographically appropriate viewers for typically commercial purposes. As generally shown, the present invention enables the advertiser A 96 to target an advertising campaign to a defined, narrowly focused demographic without requiring the overhead of discovery, selection, negotiation, configuration and monitoring of multiple individual publisher sites 16. Instead, advertisers 96, 98, 100 obtain substantial efficiencies by the management of the niche content-related community networks A-E 60, 62, 64, 66, 68, 70 under the network operating policies 74, 78 of the managing network builders 72, 76.

In accordance with the present invention, advertisers 96, 98, 100 can variously select and include multiple niche content-related community networks in distinct advertising campaigns. As generally shown, a campaign by advertiser B 98 includes networks A 62 and D 68, managed by different network builders. In the preferred embodiments of the present invention, the advertiser B 98 designates choice of a primary niche content-related community network to resolve overlaps, as represented by publisher site 88, in determining the network operating policies 74, 78 applicable to the overlap.

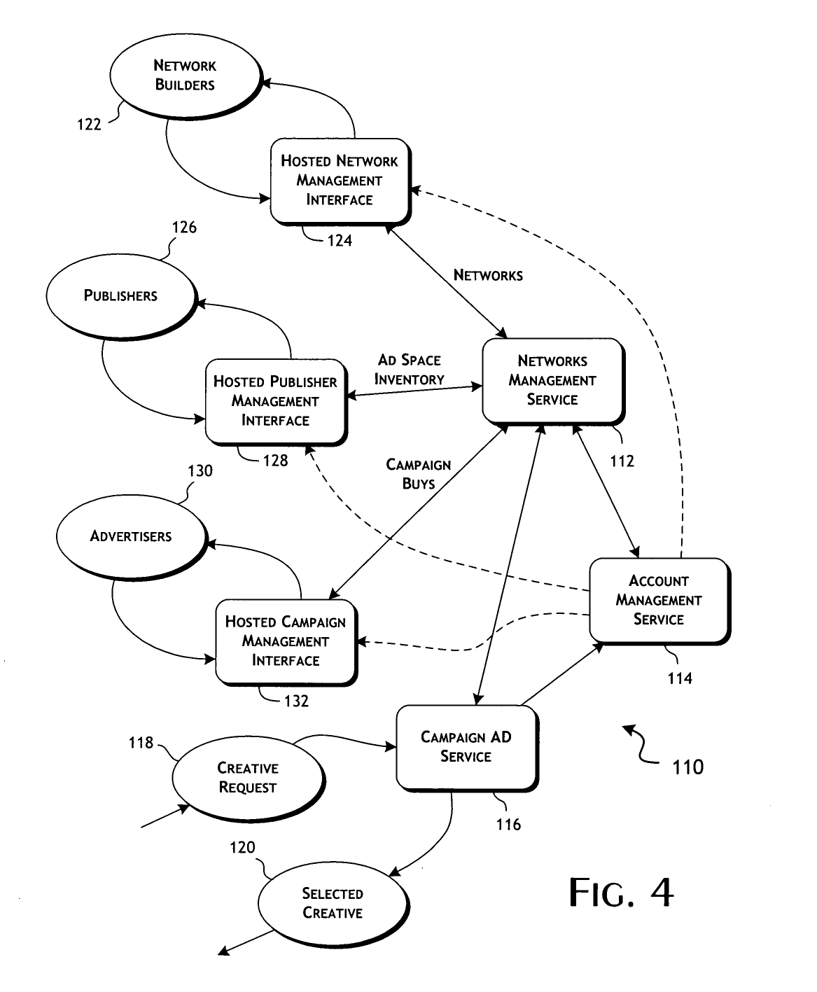

With reference to FIG. 4, the networks host server 32 and campaign advertising server 34 are preferably conventional server platforms that each implements a conventional application server stack to support execution of services capable of communicating using conventional hypertext transport (HTTP) and Web services protocols to the network builder 14, publisher site 16, and advertiser 20 servers and respond to requests from client computer systems 18. In the preferred embodiments, the networks host server 32 preferably executes a networks management service 112 and account management service 114 within the supported application server execution environment. The campaign advertising server 34 similarly executes a campaign advertising service 116 that processes, preferably in real-time, creative requests received 118 from client computer systems 18 to return 120 selective creatives.

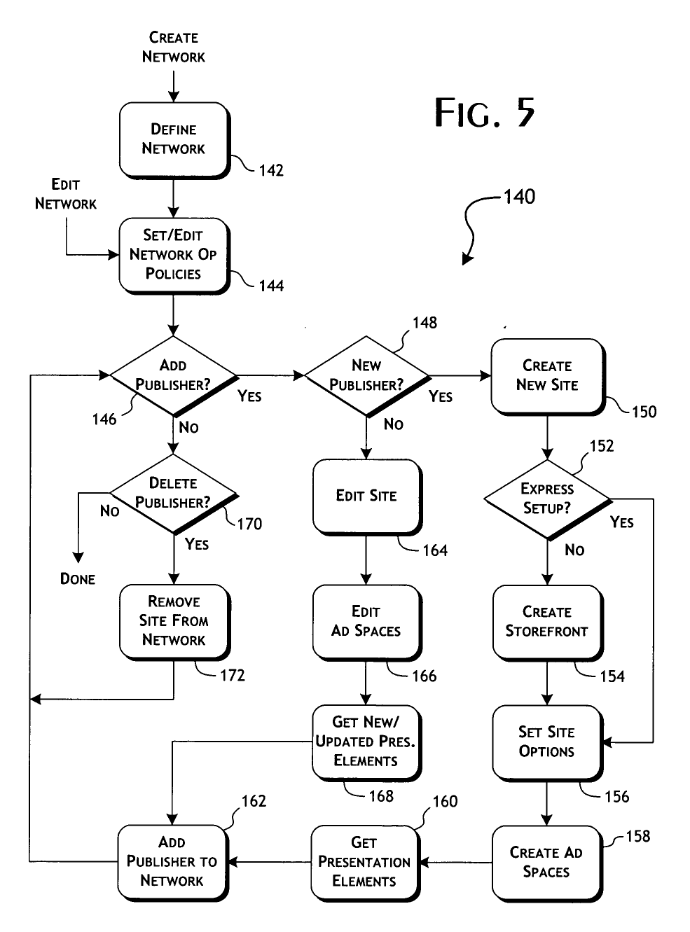

Execution of the networks management service 112 supports, directly or redirected through the network builder servers 14, a hosted network management interface 124 implemented as a user navigable series of Web browser based forms enabling interaction with individual network builders 122 preferably on an account qualified basis. The hosted network management interface 124 preferably implements the primary network builder 122 driven process 140, as shown in FIG. 5, of defining and editing individual niche content-related community networks. The entry point operations supported for a network builder 122 include the creation 142 of a new niche content-related community network 142, typically specifying intended target niche content descriptive information, and the editing of an existing niche content-related community network 144 with respect to the defining network operating policies for the network, including participation requirements, advertising campaign parameters and related requirements, and revenue share and distribution policies.

Once a new or existing niche content-related community network is selected, participating publisher sites 16 can be maintained. In adding 146 a new 148 publisher site 16, a new publisher site account is created 150, including basic identifying information for the publisher site 16 and corresponding publisher site owner 126. In the preferred embodiments of the present invention, an express publisher site setup option 152 is available to create a default configured publisher storefront that defines the hosted publisher management interface 128 accessible to the corresponding publisher site owner 126. The hosted publisher management interface 128 preferably allows the publisher site owner 126 to describe the site published content, traffic volume, audience composition, and other parameters, such as content update frequency and inventory of advertising spaces. Additionally, the hosted publisher management interface 128 enables the publisher site owner 126 to request reports on the advertising participation and revenue performance of different advertising campaigns for owned publisher sites 16. Alternately, a network builder 122 can define 154 the content and form of publisher site storefronts.

Publisher site options are then set 156, defining any additions and overrides of the default established network operating policies for an individual publisher site 16. The inventory of the publisher site 16 can then be processed 158 to specifically identify the form and type of advertising spaces existing on the available Web pages served by the publisher site 16. Corresponding presentation elements are then generated 160 and provided to the publisher site 16 for inclusion in corresponding Web pages. Inclusion of the new publisher site 16 as part of the niche content-related community network is then confirmed 162.

Where an existing publisher site 16 is to be added 148 to a new or other existing niche content-related community network, or simply to update an existing niche content-related community network and publisher site 16 relationship, the hosted network management interface 124 preferably allows aspects of the publisher site 16 account, including the storefront configuration and site options, to be edited 164. The inventory record of available advertising spaces on existing Web pages can be edited 166 to ensure accuracy. Corresponding revisions to presentation elements are made and distributed 168 to the publisher site 16 for use in updating published Web pages. The changes made are then confirmed 162. Through the hosted network management interface 124, publisher sites 16 can also be removed 170, 172 from further participation in a niche content-related community network managed by a network builder 122.

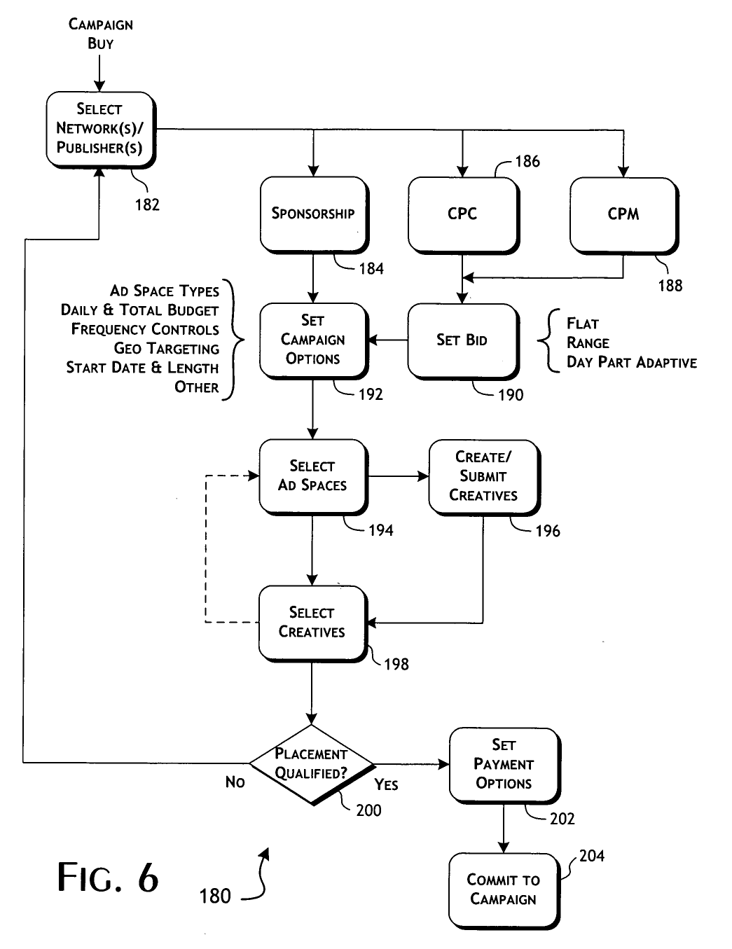

Execution of the networks management service 112 also enables advertisers 130 to access, on an account differentiated basis, a hosted campaign management interface 132 preferably implemented as a user navigable series of Web browser-based forms redirected through the network builder servers 14. Advertising campaigns by advertisers 130 are preferably placed through a campaign buy process 180, as shown in FIG. 6, using the hosted campaign management interface 132. To place a campaign buy, an advertiser 130 selects 182 one or more niche content-related community networks for participation in the campaign. Optionally in preferred embodiments of the present invention, the advertiser 130 may further sub-select individual publisher sites 16 and advertising spaces for participation in the campaign.

Campaign performance is elected on the basis of sponsorship 184 or auction 186, 188. Sponsorship is implemented as a placement buy of guaranteed creative presentations over the course of the campaign. Auctions are preferably implemented as an ongoing competitive, bid-based placement of creatives in terms of cost of viewer click-throughs 186 (cost per click-through; CPC) and viewer impressions 188 (cost per thousand impressions; CPM). Cost-based bids are set 190, further qualified as appropriate by type constraints, including flat rate bid and Vickrey auction. The formal campaign buy parameters are then set 192, preferably including choice of included advertising spaces and creative types (such as image, text, rich media, video, pop-up, pop-under, etc.), budgetary controls, typically as a function of campaign, day, and day-part, creative rotation frequency, geographic and other demographic targeting constraints, and the start date and length of the campaign. For each selected advertising space type 194, corresponding sets of creatives are generated or submitted 196 by the advertiser 130, or selected 198 from existing creatives previously submitted or otherwise retained by the network of networks host 12.

In the preferred embodiments of the present invention, the placement each advertiser campaign is conditionally qualified 200 based on a forward-looking simulation of the selected niche content-related community networks to acceptably execute the campaign. Qualification is dependent on the availability of advertising space inventory subject to the concurrent execution of other adverting campaigns on, in whole or in part, the same niche content-related community networks. Where the simulation indicates that at least the minimum campaign service level requirements set for the campaign 192 can be likely met, the campaign buy is accepted. On establishment of the payment options 202, typically defining funds availability and transfer terms, the campaign buy is committed 204 for execution. If the placement is not qualified 200, as may be due to insufficient inventory or inadequate competitive bid values to meet campaign performance requirements, the basis for the non-qualification is presented to the advertiser 130. The campaign buy can then be abandoned or the parameters of the buy adjusted to qualify for placement 200.

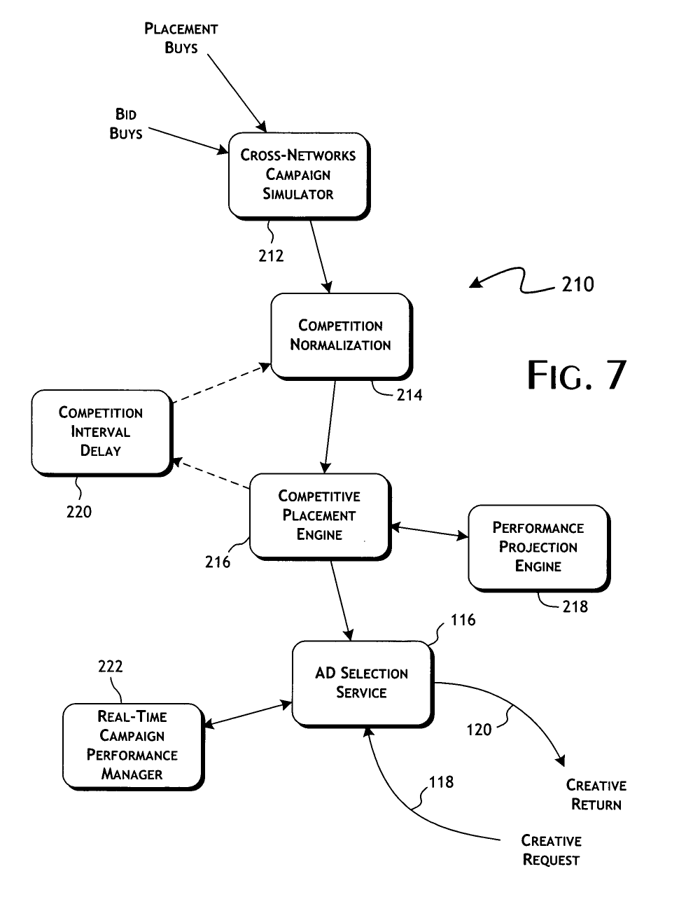

FIG. 7 provides an overview 210 of a continuous combined qualification, competition, and real-time creative service process as implemented in the preferred embodiments of the present invention. The networks management service 112, accounts management service 114, and campaign advertising service 116 enable any number of campaigns to be concurrently added and executed over the networks of niche content-related community networks while continuously operating to optimize campaign acceptance and ensure competitively balanced performance within the minimum service level constraints established for executing campaigns. This is achieved in the preferred embodiments by implementation of a gating cross-networks campaign simulator 212 that actively pre-qualifies new campaigns for acceptance actively based on the actual ongoing performance of the network of niche content-related community networks.

The preferred embodiments of the present invention further perform a continuous competitive balancing of accepted campaigns. This balancing is performed through a competitive normalization 214 of the basis for each executing campaign and production of campaign prioritization lists by a competitive creative placement engine 216. A performance projection engine 218 is preferably used to incrementally run competitive simulations based on the near-term past performance of the niche content-related community networks to provide a near-term future performance expectation as a basis for prioritization list generation. The competitive balancing operation 214, 216, resulting in potential revision of the prioritization lists, is preferably repeated whenever a new campaign is added to the set of currently executing campaigns and on expiration of a competition delay interval 220. In the presently preferred embodiments, the default delay interval is twenty-four hours, appropriate for a moderately loaded implementation of the network of networks architecture 30. By setting the resolution of the delay interval to the minimum day-part division supported in the selection of campaign parameters, an optimal competitive balancing can be obtained for large and heavily loaded networks of networks architectures 30.

Operating from the prioritization lists produced by the competitive placement engine 216, the advertisement selection service 116 evaluates creative requests 118, as received from client computer system 18, to select a prioritized campaign and corresponding creative for return 120. In the preferred embodiments of the present invention, a campaign performance manager 222 to perform a detailed real-time evaluation of campaign parameters in order to select the most appropriate creative to serve in response to a particular creative request 118.

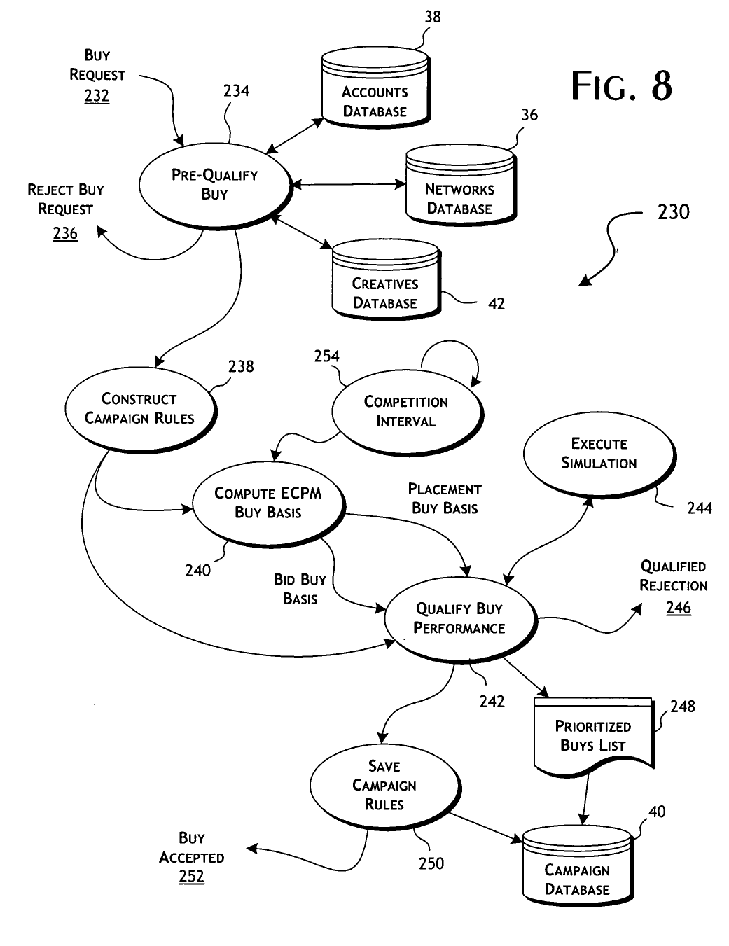

A preferred campaign qualification process 230 is shown in FIG. 8. A campaign buy request 232, received through the hosted campaign management interface 132, is parsed 234 with corresponding information being stored to the networks, accounts and creative databases 36, 38, 42. The buy request may be rejected 236 for various initial presentation reasons, including unavailability of requested networks, account status problems, and unacceptable creative formats. Where initially acceptable, a structured representation of the campaign parameters is constructed as a series of constraint rules 238, representing the service level requirements of the campaign buy. These rules are then evaluated 240 to compute a campaign normalized buy basis differentially for placement and bid buys. Preferably, placement buys are currency normalized, while bid buys are further normalized to an equivalent cost-per-thousand impressions (ECPM) value.

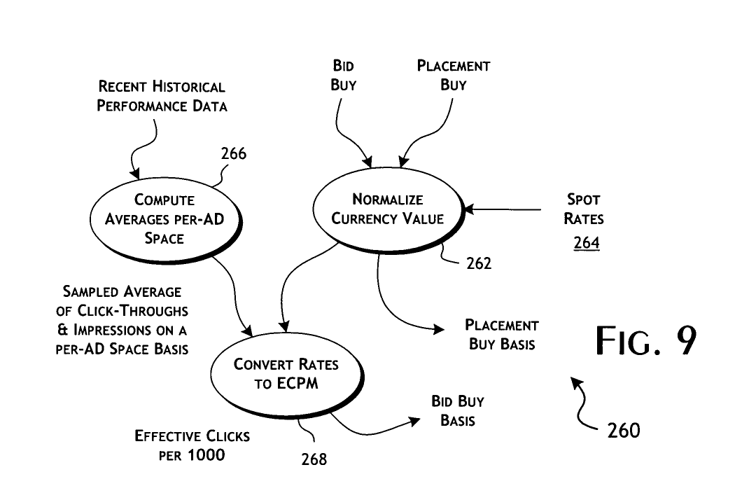

A detail 260 of the campaign normalized buy basis is shown in FIG. 9. Sets of campaign rules can be sequentially submitted for normalization. Each given set of campaign rules is initially processed 262 to normalize the various sponsorship and action bid values to a defined reference currency, such as US dollars, based on real-time retrieved currency conversion rates 264. These normalized values are saved as corresponding attributes of the campaign rules.

Further normalization of auction bids is performed to enable direct competition on the basis of ECPM values. Where the campaign rules specify auction bids in terms of CPM, the CPM values are saved as the corresponding ECPM attributes of the campaign rules. For auction bids in terms of CPC, a weighted sampled average computation is preferably used to determine corresponding ECPM values. To perform the conversion, recent historical creative performance data, as accumulated in the campaign database 40, is processed to extract advertising space sample data. In the preferred embodiments of the present invention, the sample period is defined as a seven day immediately past data window, subject to actual performance data being available. The sample data considered is further constrained to the niche content-related community networks and, where further subselected by an advertiser 130, the individual publisher sites within those networks identified by the campaign rules. Where actual performance data for specific advertising spaces is not available or statistically insufficient, estimates based on historically similarly performing advertising spaces are employed.

From the sample data, actual click throughs, average actual cost per click through (CPC), and actual impression counts are determined for each of the different advertising spaces of the inventory selected by the campaign rules, preferably at the day-part or other bid constraint resolution defined by the campaign rules. ECPM is then computed 268 as CTR*CPC*1000, where CTR (click through rate) is defined as click throughs per impressions. In the preferred embodiments of the present invention, a sampling approach is used. The ECPM for each advertising space is computed as the average ECPM of multiple discrete performance data samples randomly selected from within the sample window for each of the bid constraint resolved periods. Each data sample is defined as a number of sequential advertising space specific impressions. In one preferred embodiment of the present invention, ten data samples of 500 impressions each occurring within single day periods are used in determining the ECPM for an advertising space.

Referring again to FIG. 8, once placement and bid buy basis have been determined, the campaign buy is subjected to an inventory qualification and prioritization process 242. Placement buys are implemented as inventory reservations that must meet the service level requirements of a campaign buy. Inventory qualification of a new placement buy requires an adequate advertising space inventory to meet the service level requirements of both the new and existing placement campaigns. Inventory adequacy is determined by a forward running simulation 244 of the new and existing campaign rules against the current known advertising space inventory represented by the complement of niche content-related community networks. Preferably, the simulation iteratively resolves campaign service level requirements competitively based on the actual inventory available on the niche content-related community networks, the inventory requirements of the competing campaigns, and the normalized placement buy basis of each campaign. If the available inventory is inadequate to accommodate the new placement buy, a qualified rejection 246 is returned to the hosted campaign management interface 132. Where inventory is determined adequate, a campaign prioritization list 248, maintained by the networks management service 112, is updated to include the new campaign buy. Preferably, the campaign prioritization list 248 establishes advertising space inventory reservations in priority order based on the normalized placement buy basis of each campaign. Given that campaign rules can specify different normalized placement buy basis for different day-parts, reservations are represented in the campaign prioritization list 248 based on applicable day-part. The campaign prioritization list 248 and campaign rules are persisted 250 to the campaign database 40 and an acceptance message 252 is returned to the hosted campaign management interface 132.

The qualification of auction buys is preferably handled similar to placement buys, though without consideration of service level completion requirements. On submission of an auction buy, the forward running simulation 244 considers the unreserved advertising space inventory in determining, subject to the campaign rules of the new auction buy, whether sufficient inventory is available for completion of the advertising campaign. In performing the simulation, the different campaign rule requirements for advertising space inventory are competitively considered based on the bid ECPM of the different campaigns. If inventory is inadequate for completion of a newly submitted auction buy, a qualified rejection 246 is returned to the hosted campaign management interface 132, preferably allowing the submitting advertiser 130 to accept a reduced campaign scope or withdraw the campaign. Where acceptable, the campaign prioritization list 248 is updated to include bid buy placements in competitive priority order for the available advertising space, the campaign rules are persisted 250, and an acceptance message 252 is returned.

In the preferred embodiments of the present invention, executing campaigns, including those accepted, pending prior to the campaign start date, and those in active performance, are periodically resubmitted 254 for competitive evaluation. Specifically, the current executing campaign rule sets are sequentially retrieved, preferably in campaign acceptance 252 order, from the campaign database 40 and presented for normalization 262 and qualification 242. Depending on the then current currency conversion rates 264, re-computation of the ECPM bid buy basis, and the then actual known advertising space inventory, the campaign prioritization list 248 is updated.

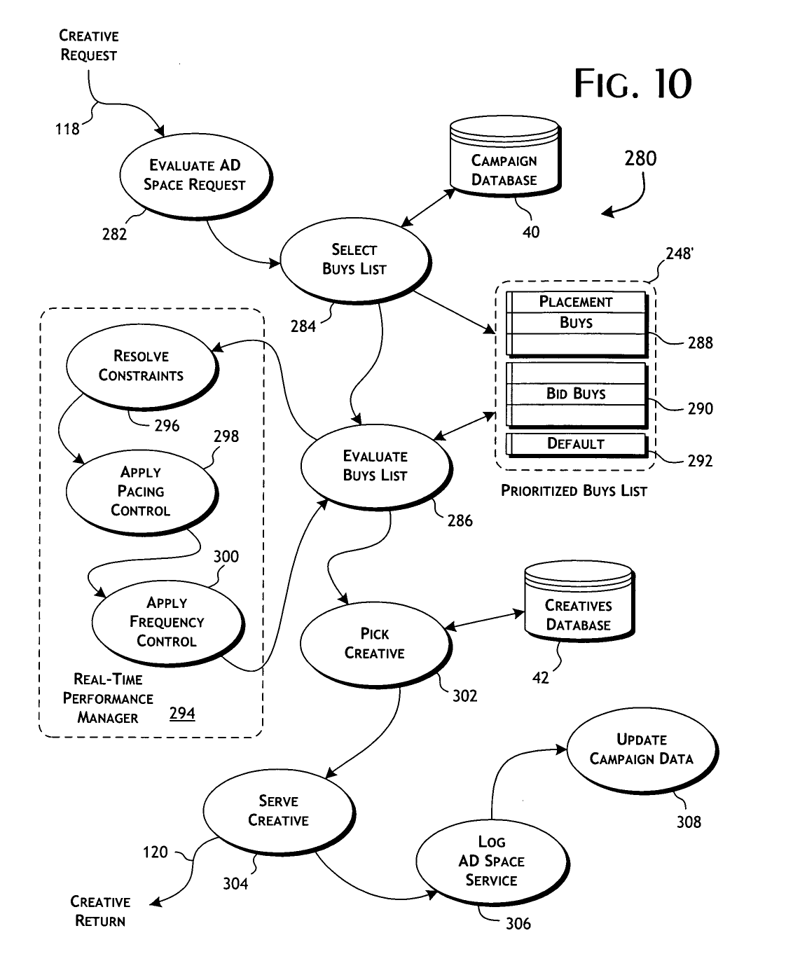

The preferred creative serving process 280 implemented by the campaign advertising service 116 is shown in FIG. 10. Creative requests 118 are preferably generated by the client local execution of presentation code blocks 44, 46, 48 for specific advertising spaces embedded in a Web page 50 instance served to a corresponding client computer system 18. Each creative request 118, as received, delivers a payload of presentation element identifying information, preferably including the information listed in Table 4, for evaluation 282 by the campaign advertising service 116.

TABLE 4
Creative Request Payload

| | |
|---|---|
| Presentation | Pre-coded specification of an advertising space |
| Element Identifier | instance on the Web page for which the presentation |
| | code block was generated. |
| Publication | Parsed information from the URI of the served Web |
| Identifier | page instance that embeds this presentation code |
| | block; provides an identifier of the publication site |
| | server and instance Web page |
| System Data | Information dynamically retrieved from the local |
| | system through the execution of the presentation |
| | code block, including: |
| | operating system type and version |
| | operating system local and browser language |
| | settings |
| | browser type and version |
| | connection type and speed |
| | creative identifier of the last creative received |
| | for this presentation element identifier |
| | other data, such as price requirements, |
| | geo-location, and frequency. |

Based on the provided publication and presentation element identifiers, a prioritized buys list 248′ is preferably sub-selected 284 from the campaign prioritization list 248 stored by campaign database 40. The sub-selection yields a prioritization list 248′ limited to the currently executing campaigns that encompass the identified publication site server for the day-part determined in relation to the locale time of the creative request 118. The resulting prioritization list 248′ thus contains, in competitive prioritization order for the current day-part, executing placement buys 288, executing auction bid buys 290, and a default buy 292. Due to existence of service level requirements, placement buys 288 will always be prioritized above the auction bid buys 290. The default buy 292 represents a default creative selection for use when no other buys are determined applicable to the creative request 118.

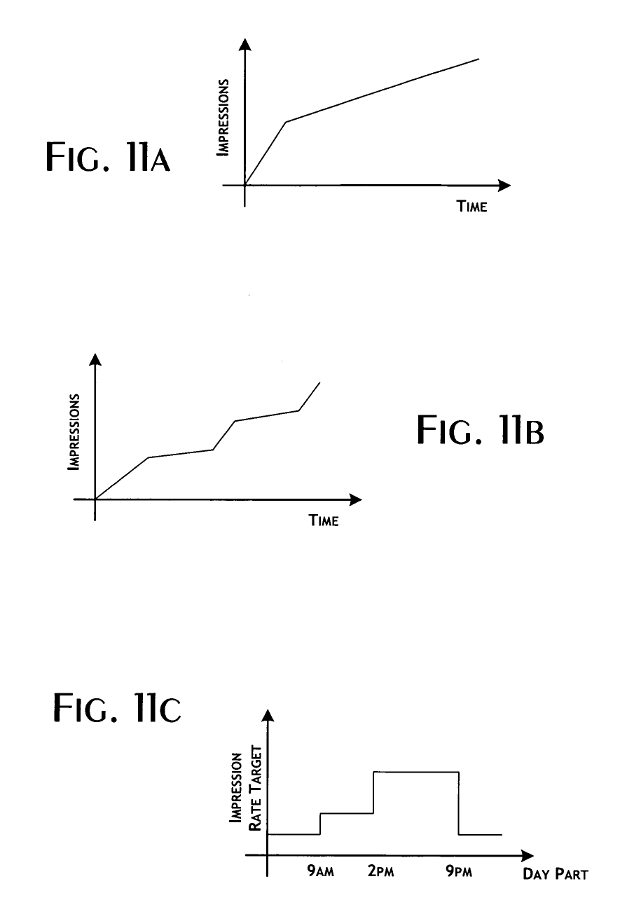

The prioritization list 248′ is then sequentially evaluated 286 preferably using a real-time performance manager 294. The campaign rules for each buy 288, 290, as retrieved from the campaign database 40, are evaluated in the priority order of the buys to qualify each buy against campaign rules defined constraints 296, pacing control limits 298, and frequency control limits 300. Upon submission of the campaign rules for a given buy 288, 290 to the real-time performance manager 294, the constraint resolver 296 initially determines whether all of the campaign rules defined constraints, preferably including start date, end date, campaign budget limit, geographical restrictions, browser language set, browser type and version, operating system and version, and connection type and speed, are met. Any constraint failure results in sequential selection 286 of the next candidate buy 288, 290.

Where all constraints pass, pacing control is applied 298. As generally illustrated in FIG. 11A, the accumulated number of impressions for each advertising space participating in a campaign can be specified by the campaign rules as a function of time. In accordance with the present invention, as generally illustrated in FIG. 11B, the campaign rules can specify an arbitrarily complex pacing function, as may be desired to align campaign performance with real-world events. A current candidate buy 288, 290 is evaluated 298 to determine, in real-time, whether the pacing limit defined by the applicable campaign rules would be exceeded by presentation of a creative for that campaign. If exceeded, the next candidate buy 288, 290 is sequentially selected 286 for evaluation.

Where the campaign is executing within the defined pacing limits, the campaign rules defining target presentation frequency of the advertising space are considered 300. As generally shown in FIG. 11C, impression frequency rate targets for each advertising space participating in a campaign can be specified by campaign rules. In the preferred embodiments of the present invention, impression frequency rates are defined in terms of a repeating day-part pattern. This allows, for example, focusing of impression delivery based on the likely viewing behavior of a target demographic. The impression frequency rate targets may be specified by campaign rules in terms of arbitrary time units, typically as impressions per minute, and, preferably, over any number of defined day-parts, such as rate X (09:00-14:00), rate Y (14:00-21:00), and rate Z (21:00-09:00). Provided a creative request is, in real-time, evaluated to fall within the impression frequency rate target of a current candidate buy 288, 290, that candidate buy is chosen 286 to provide a responsive creative. If no candidate buys 288, 290 succeed evaluation through the real-time performance manager, the default buy 292 is automatically selected.

Given a candidate buy, 288, 290, 292, the advertisement selection service 116 proceeds to select a creative 302, as part of a corresponding presentation element, for delivery 302 as the creative return 120. The presentation element identifier is resolved to a corresponding set of one or more creatives pre-stored in the creatives database 42. In the preferred embodiments of the present invention, the system data provided with the creative request 118 is evaluated as a basis of selecting a particular creative. Preferably, the system data identifies any previously selected and served creative, based on browser cookie data stored by a corresponding presentation code block 44, 46, 48 on each receipt of a creative. Where multiple creatives are associated with a presentation element identifier, a creative is selected 302 in rotation. The selected creative, prepared as a presentation element, is then returned to the originally requesting client computer system 18. The service of the presentation element is logged 306 by storage of performance data, including the date and time of service, a campaign identifier, publisher site server and Web page identification, presentation element identifier, and creative identifier, in the campaign database 40. Corresponding data is also stored 308 to the accounts database 38 to reflect a current cost accounting of the campaign progress.

Thus, a system and methods providing for the controlled construction and operation of advertising-based niche content-related network communities to aggregate and leverage a broad range of sites for the planning, implementation, and management of online advertising campaigns has been described. While the present invention has been described particularly with reference to the execution of advertising campaigns and the specific delivery of adverting creative, the present invention is equally applicable the management and delivery of other forms of information through aggregated collections of niche content-related community networks.

In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A computer system for constructing and operating a network of advertising networks in support of the real-time selection and distribution of advertising creatives to network connected client computer systems for composited presentation on Web pages served to the client computer systems, said computer system comprising:
a) a networks host server system operative to execute a networks management service to manage a plurality of advertising networks represented by advertising network configuration data,
wherein each said advertising network is associated with a set of publisher sites, wherein each said publisher site participates in a respective set of one or more of said advertising networks and less than all of said advertising networks,
wherein a plurality of advertising campaigns, respectively defined by campaign data including campaign performance requirements, are associated with said plurality of advertising networks, wherein each said advertising campaign is associated with one or more of said advertising networks,
wherein said networks management service provides for the generation of a prioritized campaign selection list, evaluateable with respect to said set of publisher sites, that specifies a campaign selection order for the selective serving of advertising creatives dependent on a performance projection made subject to said campaign performance requirements;
b) a database, coupled to said networks host server system and accessible by said networks management service, providing for the storage of said advertising network configuration data and said respective campaign data; and
c) an advertisement server system, coupled to said database, operative to execute a campaign management service to selectively serve advertising creatives in real-time response to network requests received from client computer systems, wherein said campaign management service evaluates said prioritized campaign selection list in combination with said campaign performance requirements to select a predetermined advertising creative for service in response to a predetermined network request.

2. The computer system of claim 1 wherein each campaign entry in said prioritized campaign selection list represents a corresponding normalized set of campaign performance requirements.

3. The computer system of claim 2 wherein said campaign management service is operative to store creative service performance data, incorporating data reflective of adverting creatives served by said advertisement server system, in said database and wherein said networks management service is response to said creative service performance data in performing said performance projection.

4. The computer system of claim 3 wherein said set of publisher sites represent an inventory of advertising creative spaces and wherein said creative service performance data represents an actual use of said inventory.

5. The computer system of claim 4 wherein said networks host server system is further operative to selectively qualify acceptance of advertising campaign buys comprising:
a) placement buy campaigns including criteria defining respective inventories of advertising spaces required to be served with creatives corresponding to said placement buy campaigns; and
b) bid buy campaigns having criteria defining competitive bids for advertising spaces in excess of said respective inventories of advertising spaces,
wherein said campaign management service is operative to simulate performance of said advertising campaign buys in combination with said plurality of advertising campaigns, and wherein said campaign management service is operative to accept said advertising campaign buys where said respective campaign performance requirements of said campaign buys and said plurality of advertising campaigns, as simulated, are met.

6. The computer system of claim 5 wherein said campaign management service is operative to performance by normalizing said respective campaign performance requirements to a predefined bid basis to obtain proposed advertising campaign selection constraints, and performing a projection simulation of said campaign management service performance.

7. The computer system of claim 6 wherein network requests received from client computer systems are associated with identifying information including identification of a respective publisher site, campaign pacing, campaign budget, creatives served by day part, user impression frequency per day, user geo-location, user browser, user operating system, user browser language, advertising space size and associated creatives, and wherein said campaign management service is operative to evaluate said prioritized campaign selection list selects said prioritized one of said plurality of advertising campaigns based on matching said respective campaign performance requirements against said identifying information.

8. A method, implemented on a server computer system, of constructing and operating a network of advertising networks in support of the real-time selection and distribution of creatives to network connected client computer systems for composited presentation on Web pages served to client computer systems, said computer implemented method comprising:
a) first associating a plurality of publisher sites with a plurality of advertising networks, wherein each said publisher site is associated with one or more of said advertising networks;
b) second associating a plurality of advertising campaigns with said plurality of advertising networks, wherein each said advertising campaign is associated with one or more of said advertising networks and further defined by respective campaign criteria;
c) generating a campaign prioritization list of said plurality of advertising campaigns comprehensive of said plurality of publisher sites based on a competitive analysis of said respective campaign criteria, including a normalized campaign buy basis, wherein said competitive analysis employs a past-performance based projection of a competitive completion of said plurality of advertising campaigns; and
d) serving, in real-time, advertising creatives in response to service requests received from client computer systems, wherein each said service request identifies a respective publisher site, wherein selection of an advertising creative is determined from said campaign prioritization list dependent on said respective publisher site and real-time evaluation of said respective campaign criteria.

9. The method of claim 8 wherein said each said advertising campaign is associated with less than all of said advertising networks and wherein said respective campaign criteria include criteria defining campaign completion requirements.

10. The method of claim 9 wherein said plurality of advertising campaigns includes:
a) placement buy campaigns having criteria defining respective inventories of advertising spaces required to be served with creatives corresponding to said placement buy campaigns; and
b) bid buy campaigns having criteria defining competitive bids for advertising spaces in excess of said respective inventories of advertising spaces,
wherein said step of serving dynamically evaluates said campaign prioritization list to select a prioritized one of said plurality of adverting campaigns.

11. The method of claim 10 wherein said service request is associated with identifying information including said respective publisher site, campaign pacing, campaign budget, creatives served by day part, user impression frequency per day, user geo-location, user browser, user operating system, user browser language, advertising space size and associated creatives, and wherein said step of serving selects said prioritized one of said plurality of advertising campaigns based on matching said respective campaign criteria with said identifying information.

12. The method of claim 11 wherein said step of generating is repeated at predetermined intervals to reorder said campaign prioritization list to maximize the likelihood of all of said respective campaign criteria of said placement buy campaigns being met.

13. The method of claim 12 wherein said step of serving includes updating campaign data associated with said respective campaign criteria for each creative served.

14. A method, implementable on a server computer system, of distributing creatives in response to Web-page requests originated with respect to a network of niche-oriented advertising networks, wherein the selection of creatives is made dynamically in conformance with competitive campaign constraints, said method comprising the steps of:
a) responding, in real-time, to creative requests received by an ad server with respect to a Web-pages served from a member of a network niche-oriented advertising networks of server systems, wherein said step of responding provides for the evaluation of a priority buys list to select creatives responsive to said creative requests based on a normalized bid basis, cross network competitive prioritization of pending advertising campaign selection constraints recorded in a prioritization list; and
b) qualifying an advertising campaign specification for inclusion in construction of said priority buys list, wherein said advertising campaign specification includes qualification criteria, wherein said step of qualifying includes normalizing said advertising campaign specification to a predefined bid basis to obtain proposed advertising campaign selection constraints, and performing a projection simulation of said responding step based on said pending advertising campaign selection constraints including said proposed advertising campaign selection constraints to determine whether said qualification criteria is met;
c) incorporating, dependent on whether said qualification criteria is met, said proposed advertising campaign selection constraints with said pending advertising campaign selection constraints to generate said priority buys list; and
d) re-evaluating said pending advertising campaign selection constraints at predetermined intervals with respect to the actual performance of said responding step to adjust the relative order of said pending advertising campaign selection constraints in said priorities buys list.

15. The method of claim 14 wherein said step of responding comprises:
a) receiving, by said ad server, a creative request including predetermined information including an identification of an advertising space;
b) resolving, by a performance manager executed by said ad server, said predetermined information against said prioritized buys list to select a corresponding creative, wherein said predetermined information is matched against categorized criteria defined in said prioritized buys list by said pending advertising campaign selection constraints;
d) serving said corresponding creative; and
e) updating performance data associated with said pending advertising campaign selection constraints.

16. The method of claim 15 wherein said predefined bid basis is computed as a normalized effective cost per unit of impressions, wherein effective cost per unit of impressions is computed based on a historical-data sample based projection of the correspondence between advertising revenue and advertising space impressions within the niche-oriented advertising networks identified by said advertising campaign specification for the advertising spaces identified by said advertising campaign specification.

17. The method of claim 16 wherein said advertising campaign specification includes either a bid buy criteria or a placement buy criteria, and wherein prioritization of said pending advertising campaign selection constraints corresponding to said placement buy criteria is above said pending advertising campaign selection constraints corresponding to said bid buy criteria.
